(19) United States
(12) Patent Application Publication
(10) Pub. No.: US 2004/0256885 A1
(43) Pub. Date: Dec. 23, 2004

(54) Rear spoiler with motorized vertical and angle adjustability

(76) Inventor: Le Trong Bui, Garden Grove, CA (US)

Correspondence Address: LE TRONG BUI, 10541 LAKESIDE DR. "O", GARDEN GROVE, CA, 92840, US

(21) Appl. No.: 10/797,395

(22) Filed: Mar. 10, 2004

Related U.S. Application Data
(60) Provisional application No. 60/452,973, filed on Mar. 10, 2003.

(51) Int. Cl. B62D 35/00

(52) U.S. Cl. 296/180.5

(57) ABSTRACT

A wing mechanism for the utilization of aerodynamic downward forces to a vehicle with adjustability in height and angle. The wing mechanism comprises of a four bar linkage system whereby motion is transmitted from an interiorly mounted electric motor to a worm gear transferring unit, thusly raising and lowering the linkage system of the wing mechanism. Angular adjustment of the wing member comprises of linear actuators which creates pivotal movement of the wing member indirectly to the vertical movement of the linkage system.

### CROSS-REFERENCE TO RELATED APPLICATIONS

This application claims the benefit of U.S. Provisional Patent Application Ser. No. 60/452,973, filed on Mar. 10, 2003.

### BACKGROUND OF THE INVENTION

1. Field of the Invention

Embodiments of the present invention pertain to air spoilers, wing mechanism and airfoils for a motor vehicle and more specifically to spoiler mechanism that can be electronically adjusted by the user via wired or wireless controls.

2. Related technology

Previous designs for air foils, rear spoilers, and wing mechanism are generally comprised of two types; fixed mounted on top of the vehicles' rear section and integrated body panels that are extended from the vehicle to act as spoilers. Both types are used for the basis of enhancing the drivability of motor vehicles at various speeds and track conditions. The first type, which is typically fixed mounted in terms height and angle and can only be manually adjusted when the vehicle is stop. This type is limited in the fact that adjustment for optimal performance at certain speeds and driving conditions are not possible instantaneously either by driver or a programmed computer unit. However, the one advantageous benefit of this type is that it can be mounted or adapted to all vehicles relatively easily.

Alternatively, the wing mechanism that is an integrated body panel of a specific vehicle is usually designed for mechanized outward extension from the vehicles body to act as an airfoil at certain speeds or on the users command. Though beneficial in the sense of on-the-fly adjustment is possible, this art lacks the mounting adaptability for applications of various types of vehicle body styles. Accordingly, there remains a need for an art that has the flexible mounting conditions of type one and the electronic on-the-fly adjustability of type two described above.

### SUMMARY OF THE INVENTION

In accordance with the embodiments of the invention, a wing mechanism is provided for universal mounting on any vehicle and selective adjustability in height and angle during vehicle travel for optimal downward force on a vehicle. The wing mechanism includes a base whereby pivot able legs are attached with an upper wing coupling and forms a four-bar mechanism which is rotatable and parallel. The base structure also comprises of a mounted gearbox whereby a worm and worm gear transmit and reduces the circular motion of the motor into a transaxle motion. Furthermore, a motor mounted below the vehicles' interior is coupled to the gearbox through a main axle shaft and in which motion is transferred through the gearbox and onto the legs of the four-bar mechanism by way of the transaxle drive shaft. A left and right pair of legs is preferred to create a stable structure whereby the wing is mounted to the upper wing couplings. Between the left and right leg pairs can be cross members that are fixed for rigidity.

In accordance with other aspects of the present invention, the design of the upper wing coupling are as such that the various types of wings and wing mounts can be easily attached and that the angle adjustment of the wing can be made either manually or through an actuator. The above described art, features and advantages will be more apparent in the detailed description and accompanied drawings.

### BRIEF DESCRIPTION OF THE DRAWINGS

FIG. 1 shows a perspective view of the present invention mounted on the rear section of a vehicle in accordance with a preferred embodiment;

FIG. 2 shows a perspective view of the present invention unmounted with motor actuator in accordance with a preferred embodiment; and

FIG. 3 shows an exploded perspective view of the present invention in accordance with preferred embodiment; and

FIG. 4 shows a side view of the present invention in its lowered state in accordance with the preferred embodiment; and

FIG. 5 shows a side view of the present invention in its raised state in accordance with the preferred embodiment.

### DETAILED DESCRIPTION OF THE PREFERRED EMBODIMENT(S)

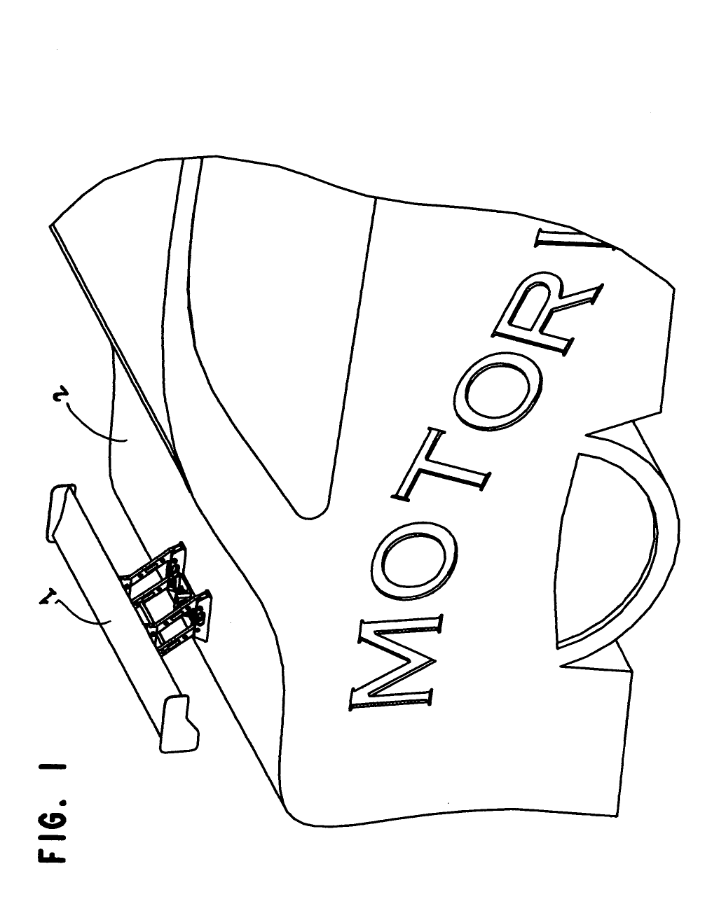

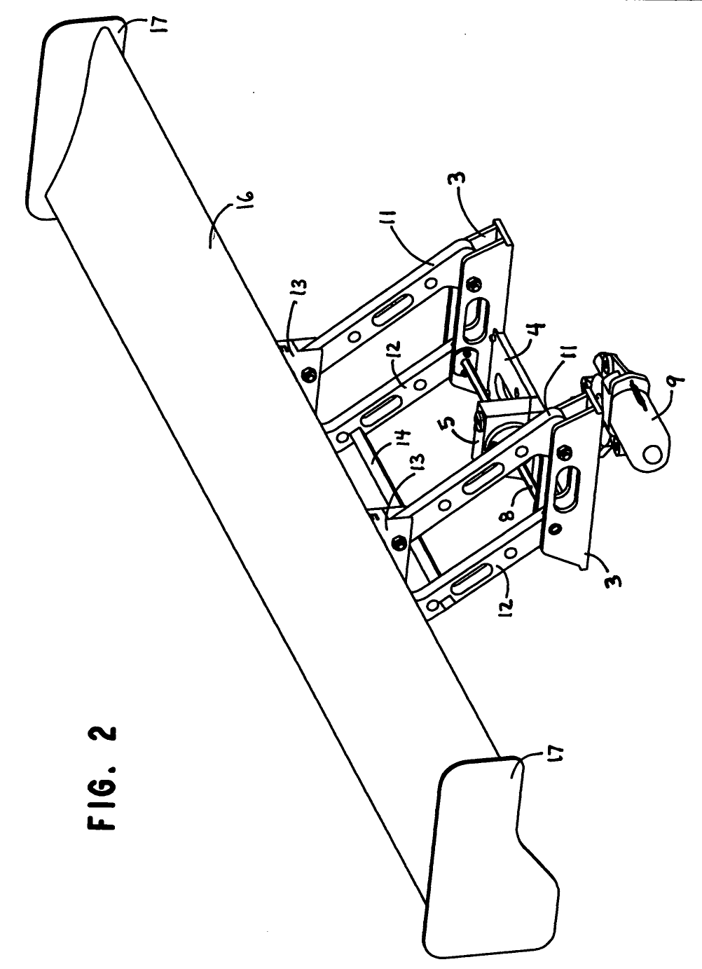

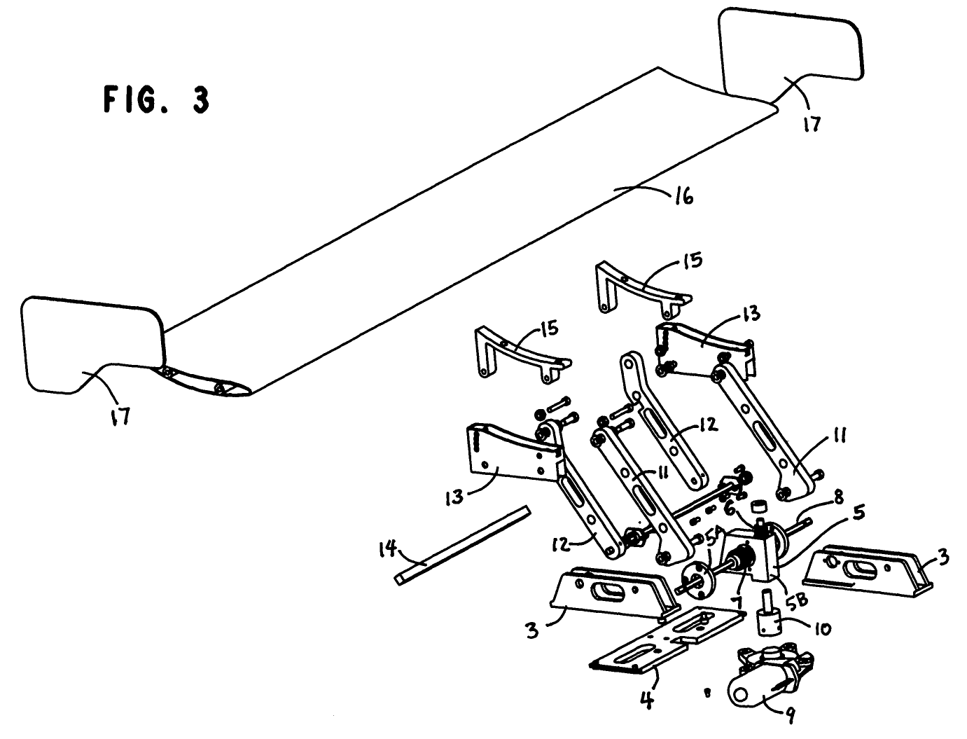

FIG. 1 shows the general application of the present invention 1 mounted on the rearward portion of a motor vehicle 2 shown as one of numerous design shapes. As an advantage of the present invention 1, the motor vehicle 2 can be of various body type such as coupes, sedans, hatchbacks, convertibles, trucks, sport utility vehicles, sport utility trucks, mini-vans and any type thereof. FIG. 2 shows the present invention with its components which defines the function of the preferred embodiments. As seen in FIG. 2 and FIG. 3, the present invention comprises of a pair of bases 3 to which a connecting plate 4 is attached and the assembly serves as the mounting interface to the motor vehicle 2. At the center of the connecting plate 4, the gearbox assembly 5 is mounted which serves as a right angle motion translator and speed reducer. Components of gear box assembly 5 consists of gear housing 5B, worm 6, a worm gear 7 and covers 5A; this particular gear type is used in the preferred embodiment in order to negate the possibility of reversing the rotational motion unwontedly. Details of the preferred embodiment are further explained in the exploded view of FIG. 3 whereby the drive mechanism is described; motor actuator 9 is mounted interiorly of the motor vehicle 2 to which the main drive shaft 10 transmit rotational motion from the motor actuator 9 to the gear box assembly 5. With rotational motion from the worm 6 to the worm gear 7, an attached transaxle shaft 8 is keyed with the worm gear 7 in order to transmit the rotational motion to the rear legs 12.

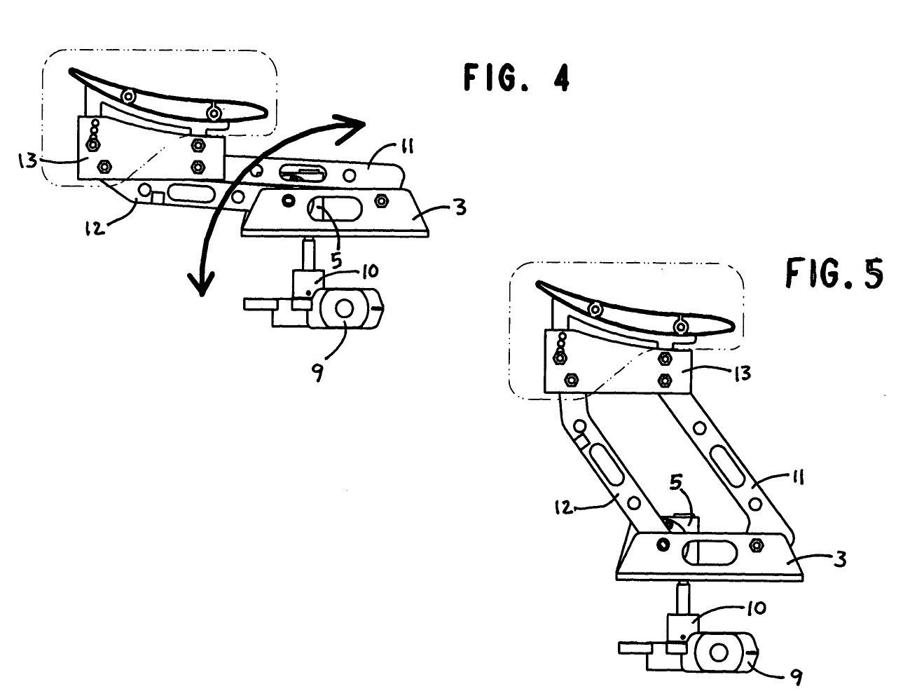

In the particular embodiment illustrated in FIG. 4 and FIG. 5, the rotational motion by the rear legs 12 directs motion of the four-bar linkage in either direction based on the controllable motor actuator's 9 rotation. Rear legs 12 and front legs 11 are set as pairs in order to create structural rigidity and when attached to the pair of upper wing coupling 13, the four-bar mechanism is created whereby motion of opposing components will travel in parallel. The four-bar mechanism is preferred in order to reduce unwanted changes in the wing's attack angle as the assembly raises and lowers; further description of the preferred embodiment will explain how angle adjustments are actuated. The upper wing couplings 13 serves as an attachment point to which wing mounting brackets 15 are attached and thusly the wing member 16 to the wing mounting brackets 15. Attached on each end of the wing member 16 are side plates 17 which are commonly used as air directors and can be any cosmetically appealing shapes.

Currently in the preferred embodiments, FIG. 4 shows a series of holes on the upper wing coupling 13 whereby the wing mounting brackets can be repositioned manually and pivot able to change the angle of attack on the wing member 16. As an alternative to the preferred embodiment, linear actuators can be mounted in the upper wing coupling 13 and connected to the wing mounting brackets 15 to selectively change the angle and whereby creates optimal and desirable downward force on the motor vehicle 2 while it is in motion.

While the wing mechanism illustrated herein represents a presently preferred embodiment of the invention, a variety of alternative embodiments may be implemented within the scope of the invention. For example, in regards to the gear actuator, while the preferred embodiment utilizes an electric motor mounted inside the vehicle's interior, in an alternative embodiment the electric motor may be situated above the vehicle's interior and attached directly or indirectly to the wing member. Furthermore, in an alternative embodiment, the electric motor utilized in the preferred embodiment can be interchange with one or more of the following motion actuators such as; hydraulic actuators, pneumatic actuators and magnetic actuators. Further, while the preferred embodiment uses a worm gear box for the translation of motion from the motor, alternative embodiments may employ one or more of the following; direct drives, belts, pulleys, spur gears, miter gears, screw gears, rack and pinions, push rods and bearings. Though the preferred embodiment utilizes two pair of legs to create stability and a parallel linkage system, other alternative arrangement of the preferred embodiment may consist of one or more of the following; one pair of legs centrally located on the vehicle, plates that acts as pivot members and support, scissor jack mechanism, slides and rods, inflatable mechanism for vertical extension. Further, while the wing mechanism of the preferred embodiment shows rotational motion of the leg pairs in the longitudinal direction of the vehicle's body, alternative embodiments may consist of one or more of the following; lateral rotating plates for straight vertical motion utilizing scissor jack mechanism, slides and rods and inflatable devices. In accordance with the preferred embodiment, components are constructed of aluminum and steel. In other embodiments, components may be constructed of one or more of the following; plastics, fiberglass, carbon fiber, aluminum alloys, steel alloys, ceramics, glass and wood.

It may be apparent to those skilled in the art that the mechanism described herein are not necessarily exclusive of other mechanism, but rather that further mechanism and mechanical features may be incorporated into the above mechanism in accordance with particular implementation to be achieved. Thusly, while the preferred embodiments illustrated in the figures and described herein are presently preferred, it should be understood that these embodiments are offered by way of example only. The invention is not limited to a particular embodiment, but extends to various modifications, combinations and permutations that are encompassed by the claims and their equivalents.

What is claimed is:

1. An electronically adjustable wing mechanism for the creation of aerodynamic downward force on a motor vehicle with height and angle adjustments, the wing mechanism comprising;
a wing assembly which mounts on the exterior portion of any motor vehicle, the wing mechanism base and upper linkage supports are attached to pairs of linkages which forms a four-bar mechanism;
an interiorly mounted electric motor actuator transmits rotational motion to a worm gear box assembly mounted on the wing mechanism base whereby motion is transferred through a drive shaft directly attached into a pair of linkages;
a wing member and wing mounting brackets are attached to the upper linkage supports through holes and creates pivotal angle adjustments.

2. The wing mechanism of claim 1, wherein the wing mechanism bases, upper linkage supports and linkages forms a four-bar mechanism and rotates longitudinally in a parallelogram in order for the selective determination of the wing angle as the mechanism is raised and lowered.

3. The wing mechanism of claim 1, wherein the linkage mechanism is pivoted in a lateral direction utilizing plates and or linkages.

4. The wing mechanism of claim 1, wherein the linkage mechanism comprises of scissor type mechanism for vertical adjustment of wing mechanism.

5. The wing mechanism of claim 1, wherein the linkage mechanism comprises of an inflatable device for the vertical adjustment of the wing mechanism.

6. The wing mechanism of claim 1, wherein the linkage mechanism comprises of a rod and slide mechanism for the vertical adjustment of the wing mechanism.

7. The wing mechanism of claim 1, wherein the motor actuator is mounted exteriorly to the vehicle and has direct drive to the linkages.

8. The wing mechanism of claim 3, wherein the motor actuator is attached to the wing assembly and has corresponding movement with the member.

9. The wing mechanism of claim 1, wherein the motor actuator is hydraulically powered.

10. The wing mechanism of claim 1, wherein the motor actuator is pneumatically powered.

11. The wing mechanism of claim 1, wherein the motor actuator is magnetically powered.

12. The wing mechanism of claim 1, wherein the wing member angle can be electronically adjusted by utilizing linear motor actuators mounted within the upper linkage supports.

13. The wing mechanism of claim 1, wherein the wing member angle can be electronically adjusted by utilizing hydraulic actuators mounted within the upper linkage supports.

14. The wing mechanism of claim 1, wherein the wing member angle can be electronically adjusted by utilizing pneumatic actuators mounted within the upper linkage supports.

15. The wing mechanism of claim 1, wherein the wing member angle can be electronically adjusted by utilizing magnetic actuators mounted within the upper linkage supports.
